(19) United States
(12) Patent Application Publication
(10) Pub. No.: US 2009/0261893 A1
(43) Pub. Date: Oct. 22, 2009

(54) SEMICONDUCTOR DEVICE INCLUDING CELL TRANSISTOR AND CELL CAPACITOR

(76) Inventor: Noriyasu KUMAZAKI, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/406,365

(22) Filed: Mar. 18, 2009

(30) Foreign Application Priority Data
Apr. 17, 2008 (JP) 2008-108050

(51) Int. Cl. G05F 1/10

(52) U.S. Cl. 327/536

(57) ABSTRACT

A semiconductor memory device includes a current source, a first resistance element, a comparator, and a charge pump. The current source supplies current to a first node. The current source includes a first transistor, and a second transistor. The first transistor supplies a drain current. The second transistor supplies a drain current. The first resistance element including a first end connected to the first node and a second end connected to a second node. The comparator compares a reference potential with a voltage of the first node. The charge pump generating a negative voltage of the sensed level based on a result of the comparison performed by the comparator, to output the generated negative voltage to the second node. The current source supplies a sum of the drain current in the first transistor and the drain current in the second transistor to the first node.

### CROSS-REFERENCE TO RELATED APPLICATIONS

This application is based upon and claims the benefit of priority from prior Japanese Patent Application No. 2008-108050, filed Apr. 17, 2008, the entire contents of which are incorporated herein by reference.

### BACKGROUND OF THE INVENTION

1. Field of the Invention

The present invention relates to a semiconductor device, and for example, to a negative voltage generating circuit.

2. Description of the Related Art

In recent years, there has been a demand to allow mobile equipment such as cellular phones to operate at low voltages and to exhibit stable operational characteristics independent of temperature. However, various problems inherent in the mobile equipment have become obvious. For example, one of the problems is an internal potential generated in a memory provided in a semiconductor device (in the description below, the case of a negative internal potential will be described).

An example of the negative potential problem will be described below. For example, a case of a DRAM will be discussed. A DRAM performs a periodic refresh operation to hold charges accumulated in a cell capacitor. However, if the negative potential swings further toward the negative side from a set value, a junction leakage current in a DRAM cell increases. This reduces the time for which the charges accumulated in the cell capacitor are held (pause characteristic). That is, the pause characteristic is disadvantageously degraded.

Thus, a conventional technique adds positive charges to the negative potential to immediately return the negative potential having swung toward the negative side, to the set value. This technique is described in, for example, Jpn. Pat. Appln. KOKAI Publication No. 2003-168293. However, the technique only deals with the problem associated with the transient increase in negative potential level. That is, the technique fails to overcome the disadvantageous difficulty in inhibiting a fundamental variation in the negative potential level.

### BRIEF SUMMARY OF THE INVENTION

A semiconductor memory device according to an aspect of the present invention includes:

a current source including a first transistor supplying a drain current which is proportional to temperature and a second transistor supplying a drain current which is inversely proportional to the temperature, the second transistor including a drain connected to the drain of the first transistor, the current source supplying current to a first node;

a first resistance element including a first end connected to the first node and a second end connected to a second node to be subjected to potential sensing;

a comparator comparing a reference potential corresponding to sensed level of the potential of the second node with a voltage of the first node; and

a charge pump generating a negative voltage of the sensed level based on a result of the comparison performed by the comparator, to output the generated negative voltage to the second node,

wherein the current source supplies a sum of the drain current in the first transistor and the drain current in the second transistor to the first node.

### BRIEF DESCRIPTION OF THE SEVERAL VIEWS OF THE DRAWING

FIG. 1 is a block diagram of a semiconductor device according to a first embodiment of the present invention;

FIG. 2 is a sectional view of a DRAM cell according to the first embodiment of the present invention;

FIG. 3 is a block diagram of a power supply generating circuit in the semiconductor device according to the first embodiment of the present invention;

FIG. 4 is a circuit diagram of the power supply generating circuit in the semiconductor device according to the first embodiment of the present invention;

FIG. 5 is a circuit diagram of a Ref circuit provided in the power supply generating circuit in the semiconductor device according to the first embodiment of the present invention;

FIG. 6 is a circuit diagram of a negative voltage generating circuit provided in the power supply generating circuit in the semiconductor device according to the first embodiment of the present invention;

FIG. 7 is a circuit diagram of a positive voltage generating circuit provided in the power supply generating circuit in the semiconductor device according to the first embodiment of the present invention;

FIG. 8 is a sectional view of a DRAM cell;

FIG. 9 is a circuit diagram of a negative voltage generating circuit;

FIG. 10 is a block diagram of a negative voltage generating circuit in a semiconductor device according to a second embodiment of the present invention; and

FIG. 11 is a diagram showing a variation in negative voltage in a semiconductor device according to a second embodiment of the present invention and a semiconductor device in a comparative example.

### DETAILED DESCRIPTION OF THE INVENTION

Embodiments of the present invention will be explained below with reference to the drawings. In this explanation, common portions or parts throughout all figures are attached with same reference numerals.

### First Embodiment

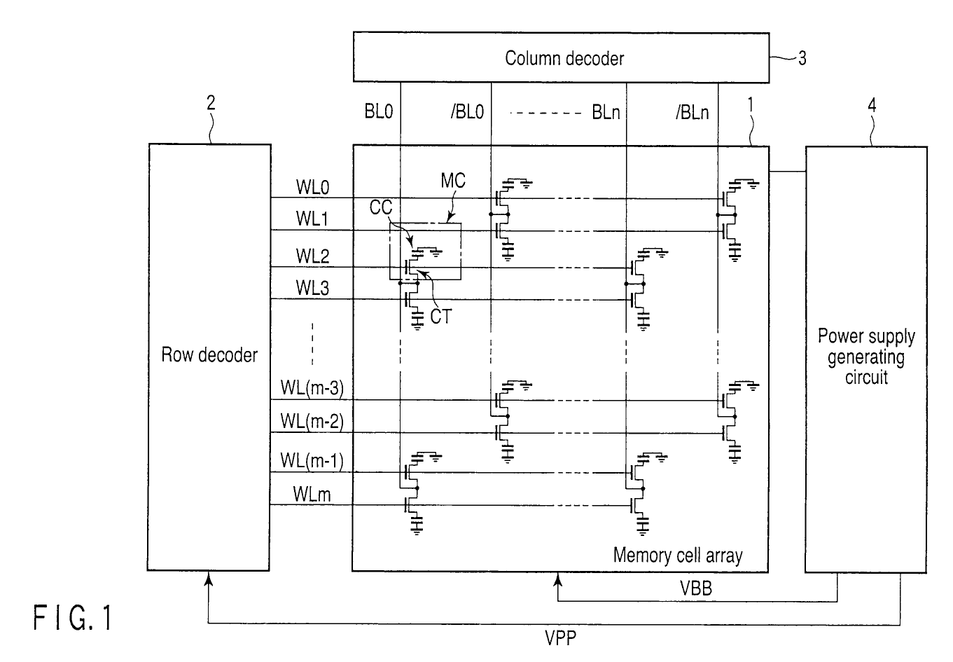

A semiconductor device according to a first embodiment of the present invention will be described with reference to FIG. 1. FIG. 1 is a block diagram according to the present embodiment. FIG. 1 shows a configuration of an LSI in which a DRAM is mounted, as an example.

### <General Configuration of the Semiconductor Device>

As shown in the figures, the semiconductor device includes a memory cell array 1, a row decoder 2, a column decoder 3, and a power supply generating device 4.

The memory cell array 1 includes a plurality of DRAM memory cells MC. Each of the memory cells MC is connected to one of word lines WL0 to WLm (m is a natural number) and one of bit lines BL0 to BLn and /BL0 to /BLn (n is a natural number). In the description below, if the word lines WL0 to WLm are not distinguished from one another, the word lines WL0 to WLm are simply referred to as the word lines WL. If the bit lines BL0 to BLn and /BL0 to /BLn are not distinguished from one another, the bit lines BL0 to BLn and /BL0 to /BLn are simply referred to as the bit lines BL and /BL.

The row decoder 2 selects a row direction of the memory cell array 1. That is, the row decoder 2 selects any of the word lines WL to apply a voltage supplied by the power supply generating circuit 4, to the selected word line WL.

The column decoder 3 selects a column direction of the memory cell array 1. That is, the column decoder 3 selects any of the bit lines BL.

The power supply generating circuit 4 generates a positive voltage VPP and a negative voltage VBB. The positive voltage is provided to the row decoder 2, which applies the positive voltage to one of the word lines WL. The voltage generating circuit 4 applies the negative voltage VBB to a semiconductor substrate on which the memory cells MC in the memory cell array 1 are formed. That is, the negative voltage VBB is used as a back gate bias for the memory cells MC.

### <Configuration of the Memory Cell Array>

Now, the memory cell array 1 will be described with reference to FIG. 1.

Each of the memory cells MC in the memory cell array 1 includes a cell transistor CT and a cell capacitor CC. The cell transistor CT includes a gate electrode connected to one of the word lines WL, a drain connected to one of the bit lines BL, and a source connected to one of the electrodes of the cell capacitor CC (this electrode is hereinafter referred to as a storage node electrode). The other electrode (hereinafter referred to as a plate electrode) of the cell capacitor CC is connected to a plate line (not shown in the drawings). The plate electrodes of the plurality of cell capacitors CC are connected together by the plate line.

In the memory cell array 1, arrangements each including the two memory cells located adjacent to each other in the bit line direction are staggered. That is, the two memory cells MC connected to the word lines WLi and WL(i+1) are connected to bit line BLj. The two memory cells MC connected to word lines WL(i+2) and WL(i+3) are connected to bit line /BLj (i and j are natural numbers, 0≦i≦m and 0≦j≦n). When read from the memory cell connected to one of the bit lines BLj and /BLj, data is sensed and amplified based on the other of the bit lines BLj and /BLj.

A method of writing and reading data to the memory cell MC configured as described above will be described in brief. For simplification, writing and reading of data to and from the memory cell MC connected to the bit line BL0 will be described. For writing and reading of data, a negative voltage VBB (for example, −0.3V) is applied as a back gate bias for the cell transistor CT.

First, writing and reading of ‘1’ data will be described. First, the pair of bit lines BL0 and /BL0 is precharged by a precharge circuit (not shown in the drawings). The bit line pair BL0 and /BL0 is allowed to float at a precharge potential. The precharge potential is, for example, VDD/2 (VDD denotes an internal power supply voltage).

Thereafter, the row decoder 2 decodes a row address to select one of the word lines WL to which the memory cell MC to be subjected to data reading or writing is connected. The row decoder 2 applies a positive voltage VPP to the selected word line WL and applies a negative voltage VNN to the unselected word lines WL. The negative voltage VNN is generated by, for example, the voltage generating circuit 4.

Then, in the memory cell MC connected to the selected word line WL, the cell transistor CT is turned on to electrically connect the pair of bit lines BL0 and /BL0 to the storage node electrode of the cell capacitor CC.

As a result, when charges are accumulated in the cell capacitor CC, charges are discharged to the bit line BL0 to make the potential of the bit line BL0 higher than that of the bit line /BL0 by +ΔV. Then, a sense amplifier (not shown in the drawings) amplifies the potential difference +ΔV appearing on the bit line pair. Thus, ‘1’ data is read.

An amplification operation of the sense amplifier increases the potential of the bit line BL0 up to about VDD. The potential of the bit line /BL0 decreases down to about VSS (ground potential=0V). The increase in the potential of the bit line BL0 also increases the potential of the storage node electrode of the cell capacitor CC up to VDD, the cell capacitor CC being provided in the memory cell connected to the bit line BL0 and the selected word line WL. Thus, the ‘1″ data is rewritten.

Now, writing and reading of ‘0’ data will be described. The same steps as those for the ‘1’ data are executed until the operations of precharging the bit line pair and selecting one of the word lines WL are completed.

When no charge is stored in the cell capacitor CC, charges from the bit line BL0 are filled into the cell capacitor CC in the memory cell MC connected to the bit line BL0 and the selected word line WL. This makes the potential of the bit line BL0 lower than that of the bit line /BL0 by −ΔV. The sense amplifier (not shown in the drawings) amplifies the potential difference −ΔV appearing on the bit line pair. Thus, the ‘0″ data is read.

The amplification operation of the sense amplifier reduces the potential of the bit line BL0 to about VSS, while increasing the potential of the bit line /BL0 to about VDD. The decrease in the potential of the bit line BL0 to VSS causes charges to be discharged from the cell capacitor CC in the memory cell MC connected to the bit line BL0 and the selected word line WL. Thus, ‘0’ data is rewritten.

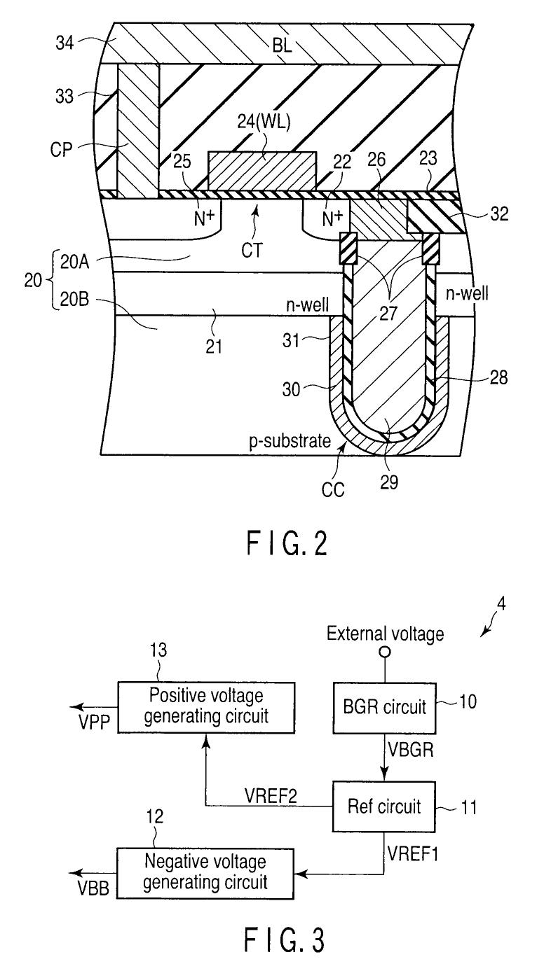

Now, the sectional structure, along the direction of the bit lines, of the memory cell MC configured as described above will be described with reference to FIG. 2.

As shown in FIG. 2, a trench 31 is formed in a p-type semiconductor substrate 20. A capacitor insulating film 28 made of a silicon oxide film or the like having a film thickness of, for example, 10 nm is formed on an inner peripheral surface of the trench 31 except for the top of the trench 31. The material for the capacitor insulting film 28 may be, instead of the silicon oxide film, an ONO film (a three-layer structure insulating film made up of a silicon oxide film, a silicon nitride film, and a silicon oxide film), an ON film (a two-layer structure insulating film made up of a silicon oxide film and a silicon nitride film), or the like. A silicon oxide film (color oxide film) 27 is formed on the inner peripheral surface of the trench 31 except for the top of the trench 31 and above the capacitor insulating film 28; the silicon oxide film has a film thickness sufficiently larger than that of the capacitor insulating film 28, for example, 30 to 40 nm.

A storage node electrode 29 is formed inside the trench 31 so as to fill the inside of the trench 31 up to the middle of the trench 31; the storage node electrode 29 is made of, for example, a polycrystalline silicon layer offering a resistance reduced by doping n-type impurities into the layer. The material for the storage node electrode 29 may be, instead of the polycrystalline silicon layer, an amorphous silicon layer or the like. A plate electrode 30 is formed in the semiconductor substrate 20 so as to cover the capacitor insulating film 28. The plate electrode 30 is formed by, for example, injecting n-type impurities into the semiconductor substrate 20. A conductor layer 26 is formed over the storage node electrode 29 in the trench 31; the conductor layer 26 is made of, for example, a polycrystalline silicon layer offering a resistance reduced by doping n-type impurities into the layer. An isolation region 32 is formed on a surface of the semiconductor substrate 20 including a part of the conductor layer 26.

A plate-like n-type buried layer 21 is formed so as to be buried inside the semiconductor substrate 20 and away from the surface of the semiconductor substrate 20. Moreover, the n-type buried layer 21 is formed such that a top surface of the layer 21 is deeper than the bottom of the silicon oxide film 27 with the large film thickness and such that the layer 21 is in contact with the plate electrode 30. For example, phosphorous (P) is doped in the n-type buried layer 21 as n-type impurities. The semiconductor substrate 20 is electrically separated into an upper region 20A and a lower region 20B by the n-type buried layer 21.

The cell transistor CT, electrically connected to the storage node electrode 29 of the cell capacitor CC, is formed on the surface of the upper region 20A of the semiconductor substrate 20. That is, the n-type source region 22 and the drain region 25 are formed in the surface of the upper region 20A so as to be spaced from each other. The source region 22 is connected to the conductor layer 26. A gate electrode (word line WL) 24 is formed on a channel region between the source region 22 and the drain region 25, via a gate insulating film 23.

As described above, the memory cell MC includes the cell capacitor CC and the cell transistor CT. An interlayer insulating film 33 is formed on the semiconductor substrate 20 so as to cover the memory cell MC. A metal interconnect layer 34 is formed on the interlayer insulating film 33. The metal interconnect layer 34 functions as a bit line BL. The source region 22 is electrically connected to the conductor layer 26 at a side wall portion of the trench 31. A contact plug CP is formed in the interlayer insulating film 33. A top surface of the contact plug CP is in contact with the metal interconnect layer 33. A bottom surface of the contact plug CP is in contact with the drain region 25.

That is, in the memory cell MC configured as described above, the capacitor is formed in the trench 31, formed in the semiconductor substrate 20. The storage node electrode 29 of the cell capacitor CC is connected to the source region 22 of the insulating gate transistor via the conductor layer 26, serving as a buried strap. The capacitor is shaped such that a test tube-like trench sticks into the plate-like n-type buried layer 21. For data reading and writing, the voltage generating circuit 4 applies the negative voltage VBB to the upper region 20A. Furthermore, for example, the row decoder 2 applies 0V to the lower region 20B and the n-type buried layer 21. Thus, the potential of the plate electrode 30 is set to 0V.

### <Detailed Description of the Power Supply Generating Circuit 4>

Now, the power supply generating circuit 4 will be described with reference to FIG. 3. FIG. 3 is a block diagram of the power supply generating circuit 4.

As shown in FIG. 3, the power supply generating circuit 4 includes a band-gap reference circuit 10 (hereinafter referred to as a BGR circuit 10), a reference voltage generating circuit 11 (hereinafter referred to as a Ref circuit 11), a negative voltage generating circuit 12, and a positive voltage generating circuit 13. The configuration of the power supply generating circuit 4 will be described.

The BGR circuit 10 is supplied with a voltage by an external power source to generate a voltage VBGR based on the supplied voltage. The BGR circuit 10 then supplies the obtained voltage VBGR to the Ref circuit 11. The voltage VBGR has constant characteristics independent of temperature. The voltage VBGR, generated by the BGR circuit 10, will be described below.

The Ref circuit 11 generates a reference voltage VREF1 based on the voltage VBGR, provided by the BGR circuit 10. The Ref circuit 11 supplies the generated reference voltage VREF1 to the negative voltage generating circuit 12. The Ref circuit 11 generates a reference voltage VREF2 based on the voltage VBGR to supply the generated reference voltage VREF2 to the positive voltage generating circuit 13. The reference voltages VREF1 and VREF2 (hereinafter simply referred to as the reference voltages VREF if the voltages are not distinguished from each other) may have the same value or different values.

The negative voltage generating circuit 12 generates the negative voltage VBB based on the reference voltage VREF1, provided by the Ref circuit 11. The negative voltage VBB, generated by the negative voltage generating circuit 12, is applied to a back gate of the cell transistor CT.

The positive voltage generating circuit 13 generates a positive voltage VPP based on the reference voltage VREF2, provided by the Ref circuit 11. The positive voltage VPP, generated by the positive voltage generating circuit 13, is provided to the row decoder 2. As described above, the row decoder 2 then applies the positive voltage VPP to the selected word line WL.

Now, the BGR circuit 10, the Ref circuit 11, the negative voltage generating circuit 12, and the positive voltage generating circuit 13 will be described. First, the BGR circuit 10 will be described.

### <BGR Circuit 10>

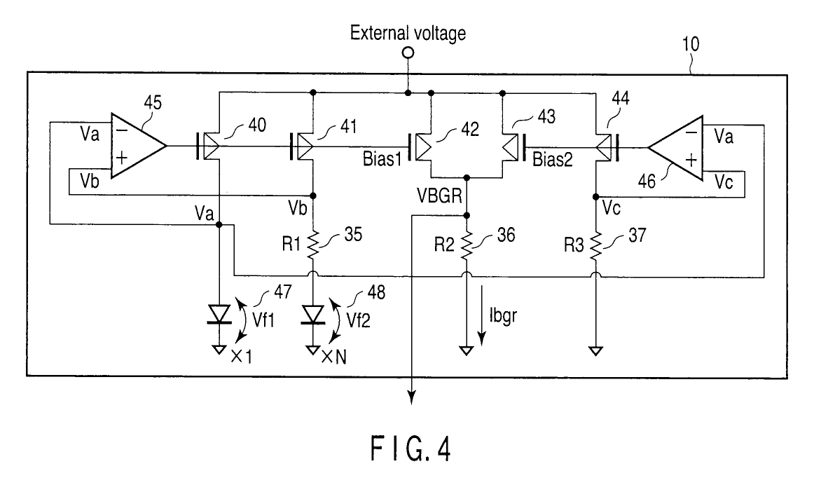

FIG. 4 is a circuit diagram of the BGR circuit 10, provided in the power supply generating circuit 4. As shown in FIG. 4, the BGR circuit 10 includes resistance elements 35 to 37, p-type MOS transistors 40 to 44, differential amplifiers 45 and 46 (hereinafter referred to as operational amplifiers 45 and 46), a diode 47, and N diodes 48 (N is a natural number) connected in parallel. The number of diodes 48 is, for example, 100 (N=100).

The BGR circuit 10 operates using a voltage provided by an external power source as a power supply voltage. When supplied with the voltage by the external power source, the BGR circuit 10 generates the voltage VBGR.

The MOS transistor 40 includes a gate connected to an output end of the operational amplifier 45 and a source to which an external power source is connected. The diode 47 includes an anode connected to the drain of the MOS transistor 40 and a grounded cathode. The potential of a connection node between the drain of the MOS transistor 40 and the anode of the diode 47 is hereinafter referred to as Va. The MOS transistor 41 includes a gate connected to an output terminal of the operational amplifier 45, a source to which the external power source is connected, and a drain to which a first end of the resistance element 35 is connected. The potential of a connection node between the drain of the MOS transistor 41 and the first end of the resistance element 35 is hereinafter referred to as Vb. A second end of the resistance element 35 is connected to anodes of the N diodes 48. The cathodes of diodes 48 are grounded. The potential of a connection node between the drain of the MOS transistor 40 and the anode of the diode 47 connected to inverting input terminals of the operational amplifiers 45 and 46. A connection node between the drain of the MOS transistor 41 and the first end of the resistance element 35 is connected to a non-inverting input terminal of the operational amplifier 45. That is, the operational amplifier 45 compares the potential Va with the potential Vb to control the gate potentials of the MOS transistors 40 and 41 so that the potentials Va and Vb are equal.

The MOS transistor 42 includes a gate connected to an output terminal of the operational amplifier 45 and a source to which the external power source is connected. The MOS transistor 43 includes a gate connected to an output terminal of the operational amplifier 46 and a source to which the external power source is connected. The drains of MOS transistors 42 and 43 are connected together, with the common connection node between the drains of the MOS transistors 42 and 43 connected to a first end of the resistance element 36. The MOS transistor 44 includes a gate connected to an output terminal of the operational amplifier 46, a source to which the external power source is connected, and a drain connected to a first end of the resistance element 37. The potential of a connection node between the drain of the MOS transistor 44 and the first end of the resistance element 37 is hereinafter referred to as Vc. A second end of the resistance element 37 is grounded. A connection node between the drain of the MOS transistor 44 and the first end of the resistance element 37 is connected to a non-inverting input terminal of the operational amplifier 46. A connection node between the drain of the MOS transistor 40 and the anode of the diode 47 is connected to an inverting input terminal of the operational amplifier 46. That is, the operational amplifier 46 compares the potential Va with the potential Vc to control the gate potential of the MOS transistor 44 so that the potentials Va and Vc are equal. The voltage of a connection node between the first end of the resistance element 36 and both the drains of the MOS transistors 42 and 43 is output as the voltage VBGR. The output voltages (comparison results) of the operational amplifiers 45 and 46 are called Bias 1 and Bias 2, respectively.

The voltage VBGR output by the BGR circuit 10 is expressed by:

VBGR=(R2/R3)*(Vf1+(R3/R1)*VT*ln(N)) (1)

where R1 to R3 denote the resistances of the resistance elements 35 to 37, Vf1 denotes a drop in the voltage of the diode 47, and VT denotes a thermo-electromotive force for the diode 48 (N is a natural number) and can be expressed as (k*T/q), where k is the Boltzmann constant, T is the ambient temperature (absolute temperature), and q is the charge amount of electrons. As is apparent from Equation 1, the temperature characteristics of the voltage VBGR can be optionally adjusted by regulating the resistance values R1, R2, and R3 of the resistance elements 35 to 37 which are set to be variable.

That is, a given voltage independent of the temperature can be generated by adjusting the resistance values R1 and R3 so that a value (∂VBGR/∂T) obtained by differentiating Equation 1 by the absolute temperature T is ‘0’. In this case, a current Ibgr flowing through the resistance element R2 is expressed by:

Ibgr=Vf1/R3+(VT1n(N)/R1) (2)

That is, by determining the resistance values R1 and R3 to maintain constant values at the voltage VGBR regardless of the temperature, the value of the current Ibgr can also be made independent of the temperature.

### <Ref Circuit 11>

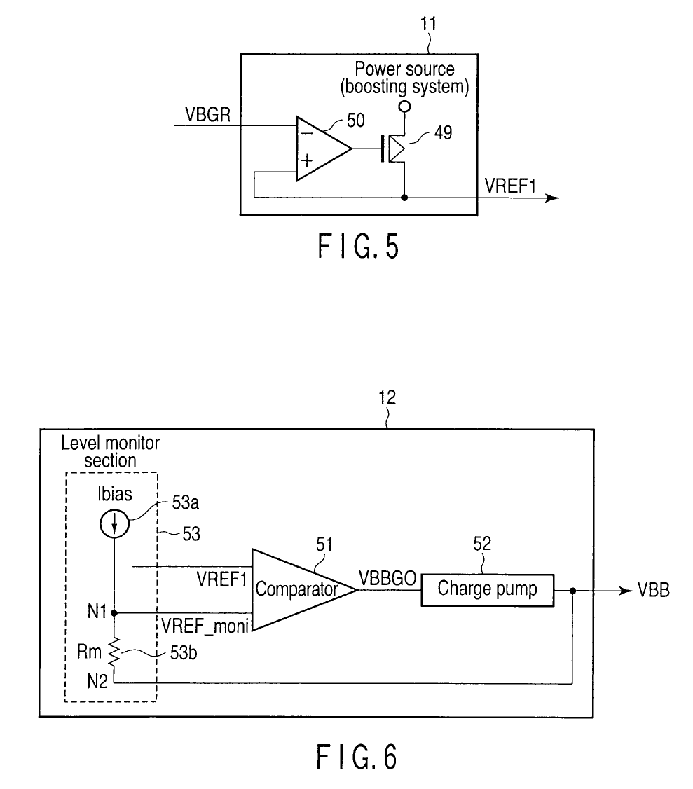

Now, the Ref circuit 11 will be described. Only a region of the Ref circuit 11 which generates the reference voltage VREF1 will be described below. FIG. 5 is a circuit diagram of the Ref circuit 11. As shown in FIG. 5, the Ref circuit 11 includes a differential amplifier 50 (hereinafter referred to as an operational amplifier) and a p-type MOS transistor 49.

The voltage VBGR supplied by the BGR circuit 10 is fed to an inverting input terminal of the operational amplifier 50. The MOS transistor 49 includes a gate connected to an output terminal of the operational amplifier 50 and a source to which an external power source is connected. The drain of MOS transistor 49 is connected to a non-inverting input terminal of the operational amplifier 50. That is, the operational amplifier 50 controls the gate potential of the MOS transistor 49 so that the drain potential of the MOS transistor 49 is equal to the voltage VBGR. The drain voltage of the MOS transistor 49 is output as the reference voltage VREF1. That is, the external voltage and the voltage VBGR from the BRG circuit 10 are applied to the Ref circuit 11, with the reference voltage VREF1 output as an output voltage. In the present embodiment, the Ref circuit 11 shown in FIG. 5 is a unity gain buffer. Namely, the magnitude of the supplied voltage VBGR is the same as that of the reference voltage VREF1.

As described above, the reference voltages VREF1 and VREF2 may be equal. In this case, the drain potential of the MOS transistor 49 may be used directly as the reference voltage VREF2.

### <Detailed Description of the Negative Voltage Generating Circuit 12>

Now, the negative voltage generating circuit 12 will be described with reference to FIG. 6. FIG. 6 is a block diagram of the negative voltage generating circuit 12. As shown in FIG. 6, the negative voltage generating circuit 12 includes a comparator 51, a charge pump 52, and a level monitor section 53.

As shown in FIG. 6, the level monitor section 53 includes a current source 53a and a resistance element 53b. An output node of the current source 53a is connected to a first end of the resistance element 53b. A connection node between the current source 53a and the resistance element 53b is hereinafter referred to as a node N1. A second end of the resistance element 53b is connected to a second node N2 to be subjected to potential sensing. The potential sensing will be described below. A voltage required to operate the current source 53a may be supplied by an external source of the semiconductor device shown in FIG. 1 or by any of the circuits included in the semiconductor device.

The comparator 51 includes a non-inverting input terminal connected to the node N1 and an inverting input terminal to which the reference voltage VREF1 supplied by the REF circuit 11, is fed. The voltage of the node N1 is called VREF_moni. An output terminal of the comparator 51 is connected to the charge pump 52.

That is, the comparator 51 compares the reference voltage VREF1 with the voltage VREF_moni. The comparator 51 then outputs the result of the comparison to the charge pump 52 as a signal VBBGO (high or low level). That is, for example, if VREF1≧VREF_moni, the comparator 51 outputs low as VBBGO. If VREF1<VREF_moni, the comparator 51 outputs high as VBBGO.

The charge pump 52 is a charge pump circuit that generates a negative voltage. The charge pump 52 generates the negative voltage VBB based on the signal VBBGO supplied by the comparator 51. The negative voltage VBB is provided to the second node N2, which is to be subjected to the voltage sensing. The charge pump 52 controls the negative voltage VBB by performing or stopping pumping so as to always maintain the negative voltage VBB at a set value (for example, −0.3V). That is, for VBBGO=high, the charge pump 52 performs pumping to drops the potential of the negative voltage VBB down to the set value. That is, the charge pump 52 reduces the potential toward the negative side (in a direction in which the potential approaches −0.3V). For VBBGO=low, the charge pump 52 stops. VBB maintained at the set voltage is applied as the back gate bias for the cell transistor CT as shown in FIG. 3.

### <Operation of the Negative Voltage Generating Circuit 12>

Now, operation of the negative voltage generating circuit 12 will be described by citing specific numerical values.

In FIG. 6, the voltage VREF_moni is expressed by:

VREF_moni=Ibias*Rm+VBB (3)

where Ibias denotes a current output by the current source 53a, and Rm denotes the resistance of the resistance element 53b. Equation 3 can be derived through application of Ohm's law.

For example, the value of the reference voltage VREF is assumed to be 1.0V, and the set value of VBB is assumed to be −0.3V. Thus, the values of Ibias and the resistance element 53b are determined such that Ibias*Rm=1.3V. Thus, for VBB=−0.3V, the voltage VREF_moni is 1.0V and thus VREF_moni=VREF1. Consequently, the signal VBBGO=low. As a result, the charge pump 52 stops.

This also applies to the case where the voltage VREF_moni is lower than 1.0V. That is, when VBB is lower than −0.3V (that is, |VBB|>0.3V), VREF_moni is lower than 1.0V. In this case, the comparator 51 outputs low as VBBGO. The charge pump 52, to which the result low is supplied by the comparator 51, stops.

When VBB is higher than −0.3V (that is, |VBB|<0.3V), the voltage VREF_moni is higher than 1.0V. In this case, the comparator 51 outputs high as VBBGO. Thus, the charge pump 52 performs pumping to reduce VBB down to the set value. That is, the pumping is performed until VBB reaches −0.3V. The charge pump 52 stops when the potential VBB reaches the set value (−0.3V).

### <Detailed Description of the Positive Voltage Generating Circuit 13>

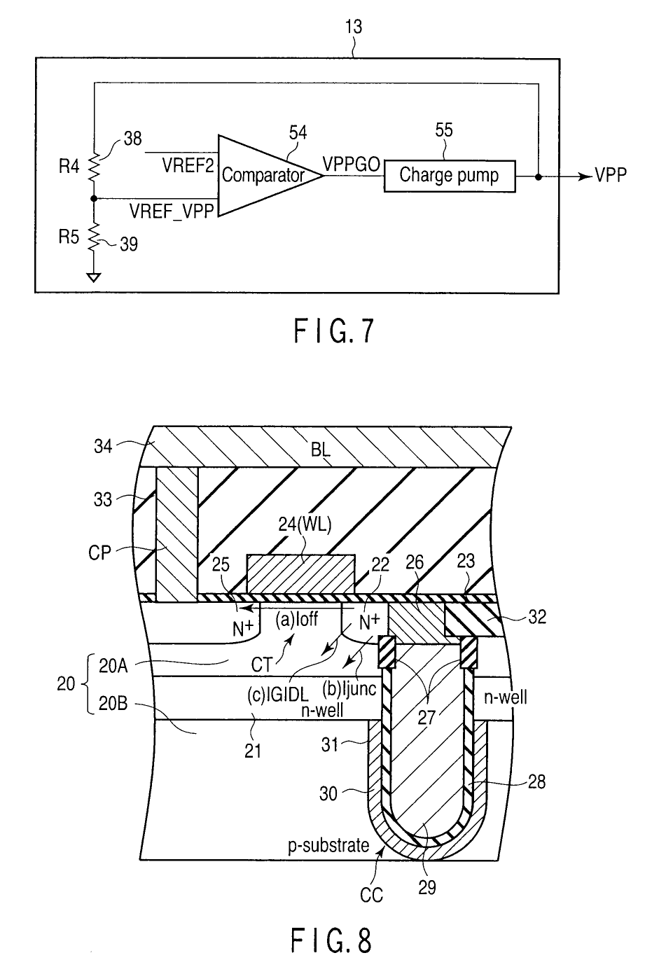

Now, the positive voltage generating circuit 13 shown in FIG. 3 will be described with reference to FIG. 7. FIG. 7 is a block diagram of the positive voltage generating circuit 13. As shown in FIG. 7, the positive voltage generating circuit 13 includes resistance elements 38 and 39, a comparator 54, and a charge pump 55. The positive voltage generating circuit 13 uses reference voltage VREF2 supplied by the Ref circuit 11, to control the positive voltage VPP. The resistance value of a resistance element 38 is defined as R4. The resistance value of a resistance element 39 is defined as R5.

First ends of the resistance elements 38 and 39 are connected in series. A second end of the resistance element 39 is connected to ground (0V). A second end of the resistance element 38 is connected to a node to be subjected to potential sensing. The positive voltage VPP, generated by the charge pump 55, is applied to the node. Thus, the value of the positive voltage VPP to be subjected to potential sensing can be checked. The resistance elements 38 and 39 are connected in series and thus serve to divide the positive voltage VPP into appropriate parts.

The comparator 54 includes a non-inverting input terminal connected to the first ends of the resistance elements 38 and 39 and an inverting input terminal to which the reference voltage VREF2 supplied by the Ref circuit 11, is fed. The potential of a connection node between the reference elements 38 and 39 is hereinafter referred to as VREF_VPP. An output end of the comparator 54 is connected to the charge pump 55. That is, the comparator 54 compares the voltage VREF2 with VREF_VPP. The comparator 54 then outputs the result of the comparison to the charge pump 55 as the signal VPPGO (high or low level). That is, for example, for VREF2>VREF_VPP, the comparator 54 outputs high as VPPGO. For VREF2≦VREF_VPP, the comparator 54 outputs low as VPPGO.

The charge pump 55 is a charge pump circuit that generates a positive voltage. The charge pump 55 generates the positive voltage VPP based on the signal VBBGO supplied by the comparator 54. The charge pump 55 controls the positive voltage VPP by performing or stopping pumping so as to always maintain the positive voltage VPP at a set value (for example, 3.2V). That is, for VBBGO=high, the charge pump 55 performs pumping to raise the positive voltage VPP up to the set potential. That is, the charge pump 55 increases the potential toward the positive side (in a direction in which the potential approaches 3.2V). For VBBGO=low, the charge pump 55 stops. The positive voltage VPP maintained at the set voltage is applied to the selected word line WL.

### <Operation of the Positive Voltage Generating Circuit 13>

Now, operation of the positive voltage generating circuit 13 will be described by citing specific numerical values.

For example, the value of the reference voltage VREF is assumed to be 1.0V. The set value of the positive voltage VPP is assumed to be 3.2V. Furthermore, the resistance value of the resistance element 38 is assumed to be 22Ω. The resistance value of the resistance element 39 is assumed to be 10Ω. As shown in the FIG. 7, a first end of the resistance element 39 is connected to the ground (0V).

For the positive voltage VPP=3.2V, the voltage VREF_VPP is the same as the reference voltage VREF2, that is, 1.0V. Thus, the comparator 54 outputs low as VPPGO. As a result, the charge pump 55 stops. This also applies to the case where the positive voltage VPP is higher than 3.2V. That is, when the positive voltage VPP is higher than 3.2V, the voltage VREF_VPP is equal to or higher than 1.0V, VPPGO is low.

When the positive voltage VPP is lower than 3.2V, the voltage VREF_VPP is lower than 1.0V. In this case, the comparator 54 sets VPPGO to high. Thus, the charge pump 55 pumps the positive voltage VPP until the positive voltage VPP reaches the set value. Once the positive voltage VPP reaches the set value (3.2V), the charge pump 55 stops.

As described above, the positive potential generating circuit 13 shown in FIG. 7 monitors the positive VPP based on the resistance type partial pressure to control the charge pump 55 via the comparator 54.

### <Effects>

As described above, the semiconductor device according to the first embodiment exerts the following effects.
(1) The scale of the circuit can be reduced, and improved the operational characteristics.

This effect will be described below in detail by citing a comparative example of the present embodiment.

First, the DRAM memory cell MC has the property of performing a periodic refresh operation in order to hold charges accumulated in the cell capacitor CC. This is to solve the problem inherent in the DRAM cell that the charges accumulated in the cell capacitor may leak owing to a leakage current (for example, off leakage or junction leakage). For example, for a high leakage current, reducing the period of the refresh operation is essential for holding the charges accumulated in the cell capacitor CC. However, the reduced period increases a standby current. This is because of the need for a circuit operation of controlling the refresh operation.

Thus, preferably, the leakage current can be reduced and the charges accumulated in the cell capacitor CC can be held for a long time. However, disadvantageously, a variation in the load voltage VBB, generated inside the memory, may increase the leakage current. This problem will be described with reference to FIG. 8. The negative voltage VBB, applied as a back bias, is used to apply a reverse bias to between the upper region 20A and the n-type impurity layer 22, functioning as a drain, to inhibit the possible leakage current between the upper region 20A and the n-type impurity layer 22.

FIG. 8 shows a sectional view of the memory cell MC. FIG. 8 is a sectional view of the memory cell MC, provided in the memory cell array 1; the sectional view is taken along the direction of the bit line BL. The same members as those in the first embodiment are denoted by the same reference numbers.

As shown in FIG. 8, the positive voltage VPP is applied to the gate electrode 24, functioning as one of the word lines WL. It is assumed that at the same time, the back gate bias VBB of the cell transistor CT is applied.

The memory cell MC is volatile, and charges thus cannot be held in the cell capacitor CC for a long time. That is, the charges accumulated in the cell capacitor CC may leak owing to a possible leakage current generated by a variation in the negative potential applied to the cell transistor CT.

For example, it is assumed that ‘1’ data is written to the cell capacitor CC by applying the positive voltage VPP to the gate electrode 24 of the cell transistor CT and VBLH (a voltage applied for selection is defined as VBLH) to the bit line BL. In this case, it is also assumed that, for example, the negative voltage VBB higher than the set value (for example, −0.3V) is applied to the cell transistor CT. For example, the value of the negative voltage VBB is more biased toward the negative side than the set value, and is, for example, −0.5V.

In this case, the effect of the back bias relatively increases a threshold for the gate more significantly than required. This reduces an off leakage current (channel leakage current, denoted by (a)I_{off} in FIG. 8). However, as shown in FIG. 8, a reverse bias is applied to a pn junction between the p-type upper region 20A and the n-type impurity layer 22, functioning as a source. An increase in VBB increases the reverse bias applied to the pn junction and thus a junction leakage current (in FIG. 8, the junction leakage current is denoted by (b)I_{junc}) induced by a crystal defect. This shortens the time for which the charges accumulated in the cell capacitor CC are held (this phenomenon is hereinafter referred to as degradation of a pause characteristic).

In contrast, it is assumed that for example, the negative voltage VBB applied to the cell transistor CT is lower than the set value (for example, −0.3V). For example, the value of VBB is more biased toward the positive side than the set value, and is, for example, −0.1V. In this case, the reverse bias applied to the pn junction between the upper region 20B and the n-type impurity layer 22 is reduced. Thus, the junction leakage is reduced. However, the back bias effect relatively reduces the threshold for the gate, thus increasing the off leakage (channel leakage) current. That is, also in this case, the pause characteristic of the memory cell MC is degraded.

This also applies to application of VNN. VNN is a negative voltage applied to the unselected word line WL (gate electrode 24). That is, an increase in VNN reduces the off leakage current but increases a leakage current (in FIG. 8, this leakage current is denoted by (c)I_{GIDL}) induced by a phenomenon called gate-induced drain leakage (GIDL). This may degrade the pause characteristic. In contrast, a decrease in VNN reduces I_{GIDL} but increases the off leakage current.

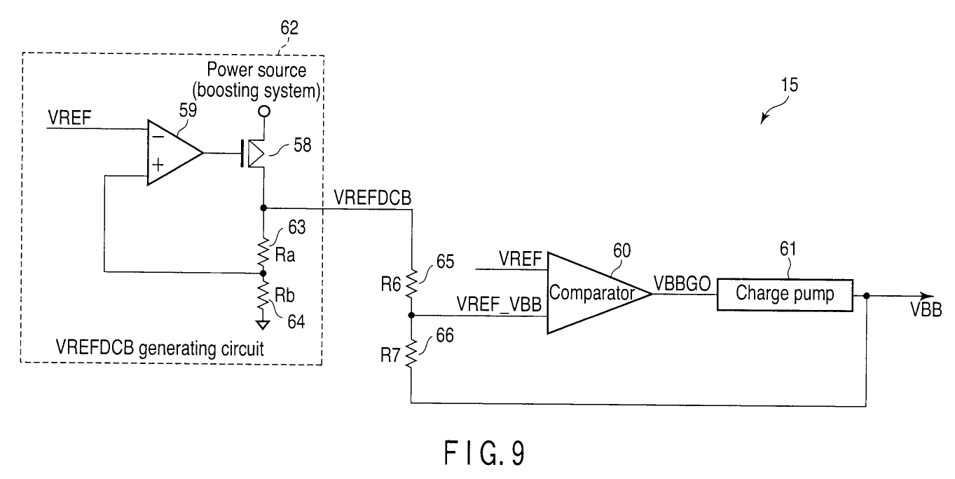

Thus, for both the negative voltages VBB and VNN, both an increase and a decrease in the absolute value of the voltage pose the adverse effects. The values of the negative voltages thus need to be set within the range of a certain window. That is, the negative voltages VBB and VNN are desirably set to be close to a central value of the window. Moreover, a given variation range for each of the set values is desirably narrower. However, a negative voltage generating circuit taken as a comparative example below may disadvantageously cause a significant variation because of the structure of a control system. The negative voltage generating circuit will be described with reference to FIG. 9.

### <Negative Voltage Generating Circuit (Comparative Example)>

FIG. 9 is a block diagram of a negative voltage generating circuit 15 in a comparative example. The negative voltage generating circuit 15 shown in FIG. 9 corresponds to the negative voltage generating circuit 12 in FIG. 3. As shown in FIG. 9, the negative voltage generating circuit 15 includes a comparator 60, a charge pump 61, a VREFDCB generating circuit 62, and resistance elements 65 and 66. The comparator 60 and the charge pump 61 are the same as the comparator 51 and charge pump 52 in the negative voltage generating circuit 12, described above, and will thus not be described.

The VREFDCB generating circuit 62 includes resistance elements 63 and 64, a differential amplifier 59 (hereinafter referred to as an operational amplifier 59), and a p-type MOS transistor 58.

An output from the operational amplifier 59 is supplied to the MOS transistor 58. An external power source is connected to the source of MOS transistor 58. A first end of the resistance element 63 is connected to the drain of MOS transistor 58. The voltage of a connection node between the drain of the MOS transistor 58 and the resistance element 63 is divided into appropriate parts by the resistance elements 65 and 66. A second element of the resistance element 63 is connected to a first end of the resistance element 64. A second end of the resistance element 64 is connected to the ground (0V). That is, a voltage output by the drain of the MOS transistor 58 is divided into appropriate parts by the resistance elements 63 and 64. The resistance of the resistance element is defined as Ra. The resistance of the resistance element 64 is defined as Rb.

The voltage VREF, generated by the above-described Ref circuit 11, is supplied to an inverting input terminal of the operational amplifier 59. The voltage of a connection node between the resistance elements 63 and 64 is supplied to a non-inverting input terminal of the operational amplifier 59. That is, the operational amplifier 59 compares the reference voltage VREF, supplied to the operational amplifier 59, with the voltage of the connection node between the resistance elements 63 and 64. As a result, the operational amplifier 59 controls a voltage applied to the MOS transistor 58 so that the reference voltage VREF and the voltage applied to the connection node are equal.

Thus, the negative voltage generating circuit 15 taken as an example requires the REFDCB generating circuit 62. This is because the comparator 60 uses the reference voltage VREF to control the negative voltage VBB to the set value. Thus, the voltage to be compared with the reference voltage VREF cannot be output only by the negative voltage VBB from the negative voltage generating circuit 15.

Thus, in the negative voltage generating circuit 15 shown in FIG. 9 as an example, the VREFDCB generating circuit 62 is additionally provided to function as a negative voltage generating circuit that controls the negative voltage VBB to the set value. Thus, to prevent the negative voltage VBB from varying, the VREFDCB generating circuit 62 desirably offers given characteristics for an external power supply voltage supplied to the VREFDCB generating circuit 62 and the temperature. However, in the illustrated negative voltage generating circuit 15, the voltage generated by the VREFDCB generating circuit 62 may vary. Furthermore, the variation may be amplified depending on the ratio of the resistances of the resistance elements 65 and 66.

This will be described below by citing a specific example.

### <Operation of the Negative Voltage Generating Circuit 15>

Now, operation of the negative voltage generating circuit 15 in the comparative example, will be described by citing specific numerical values.

For example, the negative voltage VBB is assumed to be equal to the set value (−0.3V). The potential of the reference voltage VREF is assumed to be 1.0V. The Voltage VREFDCB from the VREFDCB generating circuit 62 is assumed to be 1.6V. In this case, the voltage of a connection node between the resistance elements 65 and 66 is set to the same potential as that of the reference voltage VREF (1.0V), supplied to the non-inverting input terminal of the comparator 60. That is, in this case, the values of the resistance elements are R6=6Ω and R7=13Ω.

The illustrated negative voltage generating circuit 15 uses the resistance elements 65 and 66 to divide a difference between the negative voltage VBB and the voltage VREFDCB into appropriate parts. That is, the comparator 60 compares a voltage VREF_VBB with the reference potential VREF. Then, based on the signal VBBGO=high or low, supplied by the comparator 60, the charge pump 61 generates the negative voltage VBB. Thus, the negative voltage VBB can be expressed by:

VBB={(R6+R7)/R6}*VREF−(R7/R6)*VREFDCB (4)

where R6 and R7 denote the resistance values of the resistance elements 65 and 66. The voltage VREFDCB in Equation 4 can be expressed by:

VREFDCB=(1+Ra/Rb)*VREF (5)

where Ra and Rb denote the resistance values of the resistance elements 63 and 64. That is, since the reference voltage VREF is 1.0V as described above, the value of a resistance ratio Ra/Rb needs to be 0.6 in order to set the value of the voltage VREFDCB to 1.6V. That is, for example, the resistance element 63=6Ω and the resistance element 64=10Ω. Thus, the voltage VREFDCB for the voltage VREF_VBB to be compared with the reference voltage of 1.0V can be obtained (the voltage VREFDCB is 1.6V). However, for example, if the reference voltage VREF varies, the voltage VREFDCB becomes equal to the varied reference voltage VREF multiplied by 1.6 according to Equation 5.

Moreover, according to Equation 4, the value of the voltage VREFDCB equaling the varied reference voltage VREF multiplied by 1.6 is further multiplied by (R7/R6). Here, since the resistance element 38=6Ω and the resistance element 39=13Ω, the value of the voltage VREFDCB is multiplied by 13/6. Unlike in the case of the above-described circuit for the positive voltage VPP, in the negative voltage generating circuit, the VREFDCB generating circuit 62 may also vary the negative voltage VBB. Here, when for example, each of the values of the resistance elements 65 and 66 is assumed be 1Ω, the variation in VREFDCB by a factor of R7/R6 is prevented from being amplified (the amplification according to Equation 4 is prevented). However, even if each of the values of the resistance elements 65 and 66 is 1Ω, the component of the voltage VREFDCB cannot be deleted from Equation 4. Thus, the remaining component of the voltage VREFDCB may vary the negative voltage VBB.

Furthermore, even when the ratio of the resistance values of the resistance elements 65 and 66 is set to 1:1, the following problems remain to be solved. That is, if the voltage VBB is set to be equal to the set voltage (−0.3V), the reference voltage VREF is set to be 1.0V, and the external voltage applied to the source of the MOS transistor 58 is set to 1.8V as described above, the value of VREFDCB generated by the VREFDCB generating circuit 62 cannot be set to 2.3V.

As described above, the negative voltage generating circuit taken as an example poses the following three major problems.

### Problem 1

The negative voltage generating circuit taken as an example needs to use a boosting power source with a voltage of 2.3V for the VREFDCB generating circuit 62. That is, for low voltage operations, the voltage of the external power source is assumed to be lower than the level of the voltage VREFDCB (for example, the external power source=1.8V and VREFDCB=2.3V). Thus, the voltage of the power source needs to be equal to or higher than the voltage VREFDCB in order to allow the voltage generating circuit inside the chip (LSI) to generate the voltage VREFDCB with a sufficient operational margin. If another boosting power source is provided in the chip (LSI), the power source can be used but may increase current consumption. This is because if the boosting power source is consumed, the boosting circuit operates to compensate for the consumption of the power source, thus increasing the current consumption. If the chip (LSI) contains no such a boosting power source, a new boosting circuit is required, thus increasing the circuit scale.

### Problem 2

The negative voltage generating circuit taken as an example adopts the VREFDCB generating circuit 62, resulting in a significant variation in negative voltage VBB. That is, the variation in negative voltage VBB can be considered to be the sum of a variation in reference voltage VREF, a variation in the output from the comparator 60, and a variation in the voltage from the VREFDCB generating circuit 62. The variation in reference voltage VREF is the sum of a variation in voltage VBGR and a variation in the voltage from the Ref circuit 11. Moreover, the variation in the voltage from the VREFDCB circuit 62 is multiplied by (R7/R6).

The variation in negative voltage VBB may directly degrade the pause characteristic of the memory cell MC. That is, the degraded pause characteristic and the need to reduce the refresh period of the memory cell MC may result in an increase in standby current or the like.

### Problem 3

The negative voltage generating circuit taken as an example adopts the VREFDCB generating circuit 62 in order to divide the voltage VREF_VBB to be compared with the reference voltage VREF by the comparator 60, into appropriate parts, using the resistance elements 65 and 66. Then, if any parasitic resistance (interconnect resistance or via resistance) or the like which is different from the resistance of the resistance elements 65 and 66 is present in an interconnect between the VREFDCB generating circuit 62 and the negative voltage VBB, the partial voltage ratio of the potentials of VBB and VREFDCB (the ratio of the resistance values) may deviate. This may vary the variation in negative voltage VBB.

The above-described three problems have degraded the yield of products operating at low voltages. However, the negative voltage generating circuit according to the present embodiment enables the above-described three problems to be solved. The effects of the present embodiment on Problems 1 to 3 will be described below as Effects 1-1 to 1-3.

### (1-1) The Circuit Scale Can Be Reduced (1)

In connection with the above-described Problem 1, the negative voltage generating circuit according to the present embodiment adopts the current source as shown in FIG. 6 instead of the VDEFDCB generating circuit 62. The adoption of the current source eliminates the need for the boosting power source with a voltage of at least 2.3V, which is required for the power source used for the VREFDCB generating circuit 62. Thus, the circuit scale can be reduced.

### (1-2) The Variation in Negative Voltage Can Be Inhibited (1).

In connection with the above-described Problem 2, the semiconductor device according to the present embodiment adopts the current source instead of the VREFDCB generating circuit 62. Thus, the variation in negative voltage VBB is made up only of the variation in reference voltage VREF and the variation in the output from the comparator 52. As described above, the variation in reference voltage VREF is the sum of the variation in voltage VBGR and a variation in the voltage from the Ref circuit 11.

Thus, compared to the negative voltage generating circuit in the comparative example, the present embodiment enables inhibition of the variation in VBB and of degradation of the pause characteristic of the memory cell MC.

### (1-3) The Variation in Negative Voltage Can Be Inhibited (2).

In connection with Problem 3, the semiconductor device according to the present embodiment adopts the current source instead of the VREFDCB generating circuit 62. In the comparative example, a deviation of the negative voltage VBB from the set value increases consistently with an interconnect distance from the VREFDCB generating circuit 62 to the negative voltage generating circuit 12. That is, the parasitic resistance between the VREFDCB generating circuit 62 and the negative voltage generating circuit 12 (interconnect resistance or via resistance) may cause negative voltage VBB to deviate from the set value. However, in the present embodiment adopts the current source instead of the VREFDBC generating circuit 62, which generates the voltage. The current source offers a very high output resistance. Thus, the interconnect resistance between VREFDCB and a node monitoring the level, which is involved in the conventional art, is negligible in a practical sense. The variation in negative voltage can thus be inhibited.

### Second Embodiment

A semiconductor device according to a second embodiment of the present invention will be described. The semiconductor device according to the present embodiment corresponds to the power supply generating circuit 4 which is shown in FIG. 3 and described in the first embodiment and which includes the VBGR circuit 10, the Ref circuit 11, the positive voltage generating circuit 13, and a negative voltage generating circuit 14. That is, the present embodiment replaces the negative voltage generating circuit 12 described in the first embodiment with the negative voltage generating circuit 14.

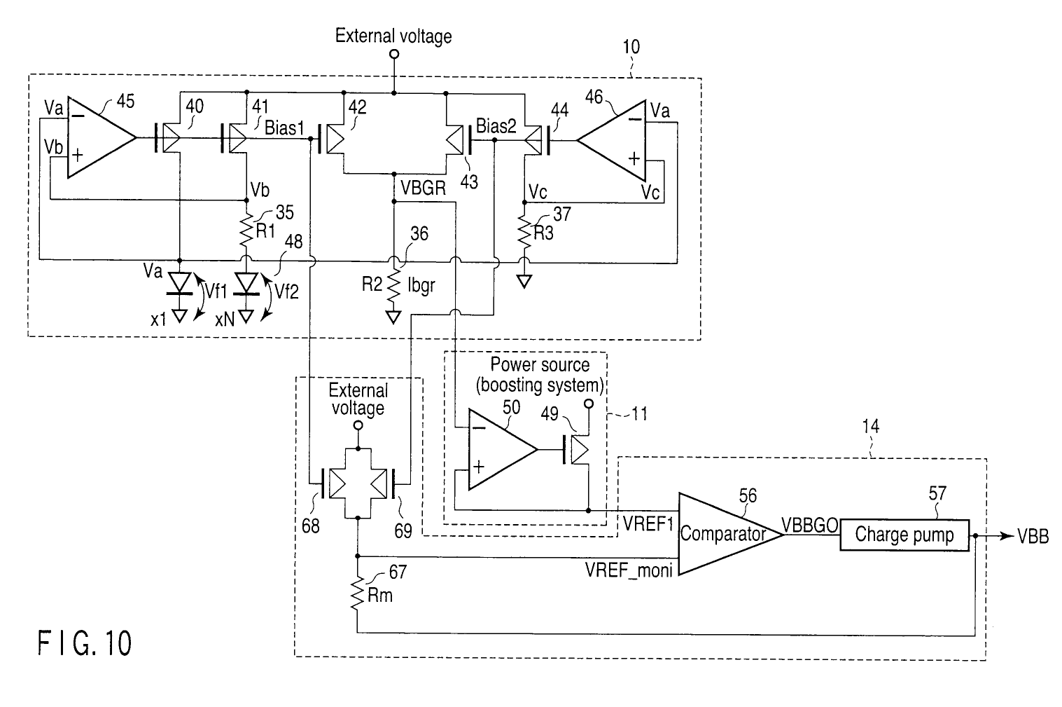

The semiconductor device according to the present embodiment allows a current mirror circuit to extract current flowing through the BGR circuit 10 according to the first embodiment. The semiconductor device then supplies the current to a resistance element 67. The negative voltage generating circuit 14 will be described below with reference to FIG. 10.

FIG. 10 is a block diagram of the BGR circuit 10, the Ref circuit 11, and the negative voltage generating circuit 14. As shown in FIG. 10, the negative voltage generating circuit 14 includes p-channel MOS transistors 68 and 69, a comparator 56, a charge pump 57, and the resistance element 67. The MOS transistors 68, 69 are configured to obtain the same current as that flowing through the BGR circuit 10. The comparator 56, the charge pump 57, and the resistance element 67 are the same as the comparator 56, charge pump 52, and resistance element 53b in the negative voltage generating circuit 12, described above, and will thus not be described.

### <MOS Transistors 68 and 69>

The MOS transistors 68 and 69 correspond to the current source 53a, described in the first embodiment. The MOS transistor 68 includes a gate connected to the output end of the operational amplifier 45 and a source to which an external power source is connected. The MOS transistor 69 includes a gate connected to the output end of the operational amplifier 46 and a source to which the external power source is connected. The sources of MOS transistors 68 and 69 are connected together. A first end of the resistance element 67 is connected to the connected sources.

That is, the MOS transistors 68 and 69 make up current mirror circuits together with the MOS transistors 41 and 44, respectively. The MOS transistors 68 and 69 have the same characteristics as those of the MOS transistors 41 and 44. That is, the MOS transistors 68 and 69 have the same threshold voltage and gate width as those of the MOS transistors 41 and 44. Thus, the drain currents in the MOS transistors 68 and 69 are equal to those in the MOS transistors 41 and 44. A current Ib flowing through the drain of the MOS transistor 41 in the BGR circuit 10 is expressed by:

I_{b}=VT1n(N)/R1 (6)

A current I_{c} flowing through the drain of The MOS transistor 44 in the BGR circuit 10 is expressed by:

I_{c}=Vf1/R3 (7)

The drain currents in the MOS transistors 68 and 69 are equal to those expressed by Equations 6 and 7. An output current from the current source 53a is 1_{b}+I_{c}. The output current from the current source 53a is expressed by Equation 2, described in the first embodiment. The current expressed by Equation 2 flows through the resistance element 67.

As described in the first embodiment, the current flowing through the MOS transistor 41 has the property of increasing in proportion to the temperature. In contrast, the current flowing through the MOS transistor 44 has the property of increasing in inverse proportion to the temperature. Thus, appropriately determining the current ratios in FIGS. Equations 6 and 7 allows I_{b}+I_{c}=I_{bias} to serve as a constant current source independent of the temperature.

Appropriately determining the current ratios in Equations 6 and 7 enables the following expression.

I_{bias}=(VBGR/R2) (8)

### <Effects>

The semiconductor device according to the present embodiment can exert the effects described in the first embodiment but also effects described in 2-1 to 2-3.

### (2-1) The Circuit Scale Can Be Reduced (2).

In the configuration according to the present embodiment, the MOS transistors 68 and 69 are provided to mirror the current flowing through the BGR circuit 10. Thus, the constant current Ibias offering no temperature characteristic is obtained. That is, the existing circuit inside the semiconductor device can be utilized to inhibit the variation in negative voltage without the need to increase layout size. Consequently, the present embodiment can reduce the circuit scale compared to the case where a new current source is provided.

### (2-2) The Standby Current Can Be Reduced.

In the configuration according to the present embodiment, The MOS transistors 68 and 69 are provided to mirror the current flowing through the BGR circuit 10. Thus, the constant current Ibias offering no temperature characteristic is obtained. Consequently, unlike in the case of the VREFDCB generating circuit 62 in the comparative example, which uses the boosting power source, the current source is configured using the external power source. As a result, the standby current can be sharply reduced.

### (2-3) The Variation in Negative Voltage Can Be Inhibited (3).

The configuration according to the present embodiment allows the supply of a more stable negative voltage than the negative voltage generating circuit according to the first embodiment.

In general, the resistance value of the resistance element 53b, described in the first embodiment, varies, though slightly, depending on a manufacturing process, the temperature, or the like. The variation occurs in, for example, the sheet resistance of the resistance element 53b. That is, if the constant voltage Ibias supplied by the BGR circuit 10 is constant, the voltage VREF_moni to be compared with the voltage VREF supplied to the comparator 56 can be expressed as (Ibias*Rm). Rm denotes the resistance value of the resistance element 67. Thus, a variation in the resistance value of the resistance element 67 varies VREF_moni. As a result, the value of the negative voltage VBB is varied via the comparator 56 and the charge pump 57.

In contrast, the present embodiment sets the output current from the constant current source 53a to a value determined according to Equation 8. Thus, the current can be prevented from being affected by the variation in the resistance of the resistance element 67. That is, when the current expressed by Equation 8 flows through the resistance element 67, a drop in voltage occurring in the resistance element 67 is expressed by Rm*(VBGR/R2). Thus, the variation in the resistance value of the resistance element 67 can be compensated for by a variation in the resistance value of the resistance element 36. This is because both the resistance elements 36 and 67 are arranged on the same substrate and manufactured by the manufacturing process, so that the level of the variation in resistance value is almost the same for both the resistance elements.

For example, it is assumed that the resistance value Rm of the resistance element 67 has varied to (Rm+ΔR). In this case, the resistance value R2 of the resistance element 36 varies by the same amount to (R2+ΔR). Thus, the adverse effect of ΔR the on the voltage drop in the resistance element 67 is negligible. As a result, the voltage VREF_moni, expressed by (Ibias*Rm), has a stable value without being affected by the variation in resistance value. That is, a stable negative voltage VBB is obtained.

As described in the first embodiment, Ibias exhibits a contact value with respect to the temperature. Thus, the voltage drop in the resistance element 67 is not affected by the resistance value or the temperature. This provides a stable negative voltage VBB independent of the variation in resistance value and the temperature.

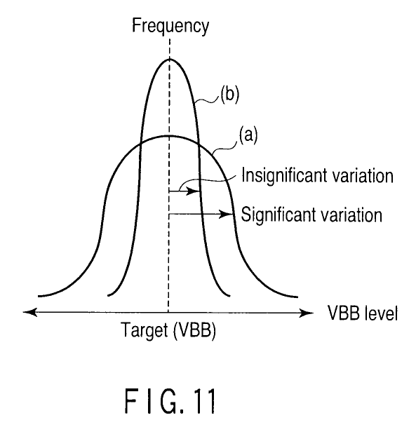

As described above, the variation in negative voltage VBB can be reduced. FIG. 11 shows the variation in negative voltage VBB with respect to the set voltage. FIG. 11 is a graph showing frequency on the axis of ordinate and the value of the negative voltage VBB on the axis of abscissa. (a) in FIG. 11 shows the distribution of the negative voltage VBB generated by the negative voltage generating circuit composed of the semiconductor device in the comparative example. (b) in FIG. 11 shows the distribution of the negative voltage VBB according to the present embodiment. As shown in FIG. 11, the configuration according to the present embodiment enables a sharp reduction in the range of a deviation in the negative voltage VBB compared to the comparative example.

As described above, the semiconductor devices according to the first and second embodiment of the present invention enables the variation in negative voltage to be inhibited. In the description of the second embodiment, the currents from both the MOS transistors 41 and 44 are used as a constant current source independent of the temperature. However, by appropriately changing the ratio of the currents flowing through the drains of the MOS transistors 41 and 44, the cell transistor CT can be controllably made independent of the temperature.

The threshold voltage of the cell transistor CT typically has the property of depending on the temperature. That is, the threshold voltage of the cell transistor CT increases with decreasing temperature. The threshold voltage of the cell transistor CT decreases with increasing temperature. In this case, if the negative voltage VBB, applied as the back gate bias of the cell transistor CT, is constant, the threshold voltage of the cell transistor CT is manifested directly as temperature characteristics. In view of the temperature characteristic of the cell transistor CT, by intentionally varying the set potential of the negative voltage VBB, described in the second embodiment, the cell transistor CT as a whole may be provided with characteristics independent of the temperature.

Thus, the negative voltage VBB may be provided with the temperature characteristics by a method described below. That is, the voltage level of the negative voltage VBB may be positively changed based on Equation 8.

First, switch circuits are installed at the respective drain ends of the MOS transistors 68 and 69. One of the currents I_{b} and I_{c} from the drain ends of the MOS transistors 68 and 69 is allowed to flow.

Second, for each of the MOS transistors 68 and 69, making up current mirror circuits together with the MOS transistors 41 and 44, respectively, a plurality of MOS transistors are provided to adjust the current ratio. That is, required numbers of MOS transistors 68 and 69 are installed according to the current ratio.

Even with the second technique, the switch circuits may be provided at the drains of the plurality of current mirror circuits so as to make the current ratio variable.

The above-described two techniques enable a change in the rate of the current flowing through the resistance element 67. Thus, the negative voltage can be provided with the temperature characteristics. A mirror current corresponding to Ibias obtained according to Equation 8 provided with the temperature characteristics flows through the common source of the MOS transistors 68 and 69.

As described above, at lower temperatures, the threshold voltage of the cell transistor CT rises. Thus, the set potential of the negative voltage VBB is shifted to the positive side. That is, as described above in the first embodiment, for example, the set voltage is shifted, for example, from −0.3 to −0.1V. Then, the cell transistor CT exhibits constant characteristics with respect to the temperature. That is, the back bias effect lowers the threshold voltage of the cell transistor CT.

Similarly, at higher temperatures, the threshold voltage lowers. Thus, the set potential of the negative voltage VBB is shifted to the negative side. That is, as described above in the first embodiment, for example, the set voltage is shifted, for example, from −0.3 to −0.5V. That is, this back bias effect raises the threshold voltage of the cell transistor CT. Thus, the cell transistor CT exhibits constant characteristics with respect to the temperature.

In the description of the first and second embodiments, the semiconductor device is LSI including DRAM by way of example. However, the present invention is applicable to LSI including, for example, a flash electrically erasable programmable read-only memory (EEPROM) instead of a DRAM.

The memory cell MC in the flash EEPROM has a memory cell transistor MT including a charge accumulation layer. The memory cell transistor MT is a MOS transistor including a stack gate (MONOS structure) with the charge accumulation layer (insulating film) formed on a p-type semiconductor substrate via a gate insulating film, a block layer composed of a material offering a higher dielectric constant that the insulating film used in the charge accumulation layer, and a control gate formed on the block layer.

The control gate is connected to one of the word lines WL. The drain of the memory cell transistor MT is connected to the bit line. The source of the memory cell transistor MT is connected to the source line. In the present configuration, depending on whether or not charges are trapped in the charge accumulation layer, the threshold voltage of the memory cell transistor MT varies to hold data.

In the flash EEPROM, the data is erased by drawing the charges from the charge accumulation layer to the semiconductor substrate. In this case, the row decoder applies an erasure voltage (for example, −7V) to the word line. The above-described negative voltage generating circuit can be used to generate the erasure voltage. For the erasure, the drain of the memory cell transistor MT is allowed to float, with, for example, 5V applied to the source of the memory cell transistor MT. Thus, description will be given of means for setting the negative voltage to −7V, the negative voltage being output by the negative voltage generating circuit 12 or 14 according to the first or second embodiment, respectively. FIG. 10 will be referenced below in describing the negative voltage generating circuit.

For example, a method is available for setting the resistance of the resistance element 67 in the negative voltage generating circuit 14 in FIG. 10 to a predetermined value. Here, the reference voltage VREF1, supplied to the comparator 56 in FIG. 10, is assumed to be 1.0V. The voltage of a first end of the resistance element 67, connected to an output node of the charge pump, is assumed to be 0V. The constant current Ibias is assumed to be 1 A.

The charge pump 57 outputs a predetermined potential so as to eliminate a difference between potential applied to the inverting input terminal of the comparator 56 and the potential applied to the non-inverting input terminal of the comparator 56, that is, so as to make the potentials of reference voltage VREF1 and the voltage VREF_moni equal. Under the above-described conditions, the resistance value of the resistance element 67 needs to be set to 8Ω in order to set negative voltage VBB to −7V.

That is, since the voltage applied to the resistance element 67 is 8V, the charge pump 57 needs to output a potential of −7V in order to set the potential of the voltage VREF_moni for the comparator 56 to 1V. That is, the charge pump 57 generates the negative voltage VBB of −7V so as to make the potentials of the input terminals of the comparator 56 equal. Thus, the potential of the first end of the resistance element 67 varies from the current value of 0 to −7V. This sets the value of the negative voltage output by the negative voltage generating circuit 12 or 14 to −7V.

Even if the first or second embodiment is applied to the flash EEPROM, effects similar to those of the first or second embodiment can be exerted.

In the above description, EEPROM includes the MONOS structure. However, the memory cell may have an FG structure. In the FG configuration, the stack gate includes a floating gate (conductive layer) formed on a p-type semiconductor substrate via a gate insulating film and a control gate formed on the floating gate via an inter-gate insulating film.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor memory device comprising:
a current source including a first transistor supplying a drain current which is proportional to temperature and a second transistor supplying a drain current which is inversely proportional to the temperature, the second transistor including a drain connected to the drain of the first transistor, the current source supplying current to a first node, a sum of the drain current in the first transistor and the drain current in the second transistor to the first node;
a first resistance element including a first end connected to the first node and a second end connected to a second node to be subjected to potential sensing;
a comparator comparing a reference potential corresponding to sensed level of the potential of the second node with a voltage of the first node; and
a charge pump generating a negative voltage of the sensed level based on a result of the comparison performed by the comparator, to output the generated negative voltage to the second node.

2. The device according to claim 1, further comprising a band-gap reference circuit generating a constant voltage independent of the temperature,
wherein the reference voltage is generated based on the constant voltage,
the band-gap reference circuit includes:
a third transistor supplying a drain current which is proportional to the temperature;
a fourth transistor supplying a drain current which is inversely proportional to the temperature and including a drain connected to the drain of the third transistor; and
a second resistance element including a first end connected to the drains of the third and fourth transistors,
the band-gap reference circuit outputs a voltage generated by the second resistance element as the constant voltage,
the gate of the first transistor is connected to the gate of the third transistor, and
the gate of the second transistor is connected to the gate of the fourth transistor.

3. The device according to claim 1, wherein a sum of the drain current in the first transistor and the drain current in the second transistor is independent of the temperature.

4. The device according to claim 1, wherein the sensed level is controlled by making the sum of the drain current in the first transistor and the drain current in the second transistor dependent on the temperature.

5. The device according to claim 1, further comprising a memory cell array including a plurality of memory cells formed on a semiconductor substrate,
wherein the negative voltage generated by the charge pump is allowed to be applied to a back gate or a word line of each of the memory cells.

6. The device according to claim 2, further comprising:
a fifth transistor including a source end to which an external voltage is applied; and
a reference circuit including a comparator comparing a voltage at a drain end of the fifth transistor with the constant voltage, while controlling a voltage provided to the gate of the fifth transistor so that the voltage at the drain end and the constant voltage are equal.

7. The device according to claim 5, wherein the memory cell is DRAM or EEPROM.

8. The device according to claim 5, wherein the negative voltage generated by the charge pump is controlled according to a threshold for the memory cell.

9. A semiconductor device comprising:
a current source supplying a current to a first node;
a first resistance element including a first end connected to the first node and a second end connected to a second node to be subjected to potential sensing;
a comparator comparing a voltage at the first node with a reference voltage corresponding to a sensed level of a potential at the second node; and
a boosting pump generating a negative voltage of the sensed level based on a result of the comparison performed by the comparator, to output the generated negative voltage to the second node.

10. The device according to claim 9, wherein the current supplied to the first node by the current source is independent of temperature.

11. The device according to claim 9, further comprising a band-gap reference circuit generating a constant voltage independent of the temperature,
wherein the reference voltage is generated based on the constant voltage,
the band-gap reference circuit includes:
a first transistor supplying a drain current which is proportional to the temperature; and
a second transistor supplying a drain current which is inversely proportional to the temperature and including a drain connected to the drain of the first transistor; and
a value for the drain currents generated by the first and second transistors is equal to a value for the current supplied to the first node by the current source.

12. The device according to claim 11, wherein the current source includes:
a third transistor forming a first mirror circuit together with the first transistor;
a fourth transistor forming a second mirror circuit together with the second transistor and including a drain connected to the drain of the third transistor,
wherein the drains of the third transistor and the fourth transistor are connected to the first node.

13. The device according to claim 9, wherein the sensed level is controlled by making the current dependent on the temperature.

14. The device according to claim 9, further comprising a memory cell array including a plurality of memory cells formed on a semiconductor substrate,
wherein the negative voltage generated by the charge pump is allowed to be applied to a back gate or a word line of each of the memory cells.

15. The device according to claim 11, further comprising:
a fifth transistor including a source end to which an external voltage is applied; and
a reference circuit including a comparator comparing a voltage at a drain end of the fifth transistor with the constant voltage, while controlling a voltage provided to the gate of the fifth transistor so that the voltage at the drain end and the constant voltage are equal.

16. The device according to claim 14, wherein the memory cell is DRAM or EEPROM.

17. The device according to claim 14, wherein the negative voltage generated by the charge pump is controlled according to a threshold for the memory cell.

18. A semiconductor device comprising:
a first resistance element including a current path with a first end connected to a first node and a second end connected to a second node;
a second resistance element including a current path with a first end connected to the second node and a grounded second node;
a comparator comparing a reference voltage corresponding to a sensed level of a potential at the first node with a voltage at the second node; and
a charge pump generating a positive voltage of the sensed level based on a result of the comparison performed by the comparator, to output the generated positive voltage to the first node.

19. The device according to claim 18, further comprising a band-gap reference circuit generating a constant voltage independent of the temperature,
wherein the reference voltage is generated based on the constant voltage,
the band-gap reference circuit includes:
a first transistor supplying a drain current which is proportional to the temperature;
a second transistor supplying a drain current which is inversely proportional to the temperature and including a drain connected to the drain of the first transistor; and
a third resistance element including a first end connected to the drains of the first and second transistors,
the band-gap reference circuit outputs a voltage generated by the third resistance element as the constant voltage.

20. The device according to claim 18, further comprising a memory cell array including a plurality of memory cells formed on a semiconductor substrate,
wherein the positive voltage generated by the charge pump is allowed to be applied to a word line of each of the memory cells.
